(19) United States
(12) Patent Application Publication
(10) Pub. No.: US 2018/0113915 A1
(43) Pub. Date: Apr. 26, 2018

(54) Drove mobile application system and method

(71) Applicant: Kolin Blain Porter, Tempe, AZ (US)

(72) Inventor: Kolin Blain Porter, Tempe, AZ (US)

(21) Appl. No.: 15/732,279

(22) Filed: Oct. 18, 2017

Related U.S. Application Data
(60) Provisional application No. 62/496,665, filed on Oct. 26, 2016.

(51) Int. Cl. G06F 17/30; G06Q 50/00; G06Q 30/02

(52) U.S. Cl. CPC G06F 17/30539; G06F 17/30864; G06Q 30/0201; G06Q 50/01

(57) ABSTRACT

The present invention presents visual display of vast amounts of information found in educational, professional, and social databases for providing concentrated information through visualization and infographics to students seeking an institution of higher education such as Colleges and Universities. The concentrated information is focused on a student's preferences and educational objectives. An institution of higher education is selected by a student's preference in institution location or education objectives. A pertinent selection criteria is also concentrated on institutions of higher education selected by a student's group of student friends who are also seeking an institution of higher education. By knowing where student friends are selecting institutions of higher education, a student can know, through this mobile application of the present invention where friends are enrolling in other institutions.

### CROSS-REFERENCE TO RELATED APPLICATIONS

Incorporated by reference is US patent application U.S. 62/496,665

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Compact disk 1 for iOS™ download of Drove Mobile Application System and Method, compact disk 2 for duplicate iOS™ download of Drove Mobile Application System and Method both disks contain a droveapp File Folder with programs GITIGNORE File 1 KB and README.md File 2 KB.

### STATEMENT REGARDING PRIOR DISCLOSURES BY THE INVENTOR OR A JOINT INVENTOR

“Not Applicable”

### BACKGROUND OF THE INVENTION

### (1) Field of the Invention

The field of this invention is data visualization of large sets of data or networks. The field is in visual display of data to provide understanding of the data and meaning to the large amount of information found in educational and social networks for providing guidance to students entering higher education to lead to professional employment.

### (2) Description of Related Art Including Information Disclosed Under 37 CFR 1.97 and 1.98

The field of higher education is addressed in this background to the present invention, Drove Mobile Application System and Method.
Higher education is changing with the following factors being primary reasons:

Higher Education costs are rising. The national average cost of attending a four-year public college is over $28,000 per year, expected to increase 6.5% annually, according to Forbes. Student loans are piling up, dropout rates are seriously high, and employer needs are constantly changing:
1. Student loans are piling up:
   Total outstanding student debt has quadrupled since 2000 to $1.2 trillion today and more than a fifth of that debt is at least 90 days' delinquent, according to the Federal Reserve Bank.
2. Dropout rates are seriously high:
   Among students who enrolled in nonprofit colleges, on average, only half graduated from such institutions within six years, according to May by Third Way.
3. Skills employers want are ever-changing:
   There are over 500,000 computing jobs currently unfilled but only 42,969 CS graduates/year, according to CSE coalation.org.
   The Drove Mobile Application. System and Method highlights college majors or schools to students that prepare them for highly-in demand jobs, which is an objective of the present invention.
The importance of finding the right education has never been more important.
   1. It's not a decision to make lightly, it's something potential students need to put time, effort and money into making a right decision.
   2. Starting a wrong major or attending an incompatible institution causes serious financial burden on too many young people.
High school students of the present generation and their perceptions on college, education, and future employment are in constant change.

### Education Factors:

Both juniors and seniors in high school are interested in furthering their education
   There are currently 3.3M students who graduate from high school every year, about 66% of them enroll in college immediately in the fall −˜2.2 million people, according to NCES.
Colleges and universities will spend heavily to reach the right students.
   $3B spent on advertising by colleges & universities every year.
   70+% spent on Facebook and Google yearly.
   6% of Facebook and Google entire yearly revenue is from Education and Job Marketing.
Schools are rapidly moving advertising dollars from traditional formats to digital and social networks. The present invention, Drove Mobile Application System and Method uses digital education and social networks to produce data visualizations to convey focused information to students, aggregating personal profiles, preferences in education fields, and location of institutions of higher learning to allow a student to quickly focus in a more narrow selection of institutions. A further factor provided by the present invention is information of peer decisions as to their selection of institutions of higher education, providing a further factor of which institution to select.

Therefore, it would be highly advantageous to provide prospective students of higher education with A Drove mobile application system and method which incorporates the following objectives in a system and method to:
i. Harvest social, public or personally authorized data to create profiles combining data from multiple third party endpoints;
ii. Abstract logical façade for profile attributing of personal/professional/educational data across multiple sources, exposed via web services and API;
iii. Collect Infographics and visualizations of data from networks and multiple data points;
iv. Use a simplified design render layer on top of geolocation plus profile data to make more interesting and artistic representations of data;
v. Layer data on a web and mobile accessible visualization render canvas mapped to geolocation, including layers for physical locations, profile locations, location data related to education and employment;
vi. Create user networks and groups based on algorithms for finding interest in schools, jobs, and brand impact;
vii. Use harvested social, public, or personally authorized data to create an independent graph to search for profile common traits;
viii. Mine data from third parties for trends, impact, and marketing efforts across current largest social networks;
ix. Import data from external networks into structured common and standardized attributes;
x. Use harvested social, public or personally authorized date to predict following, attendance and market event successes;
xi. Use harvested information from common social, public and personally authorized data to find key influencer users/profiles that brands and advertising campaigns can reward for more impact;
xii. Aggregate Social Network Data to create visualization. Gamify profile creation to encourage harvesting of profile data using external sources;
xiii. Synchronize profiles across web, mobile, desktop using unique identifier; and
xiv. Attach attributes to unique identifier as an attribute tree of an individual user, allowing multiple third party authentication systems and apis to attach data to a user.

### BRIEF SUMMARY OF THE INVENTION

The present invention provides visual display of vast amounts of information found in educational and social databases for providing concentrated information to students seeking an institution of higher education such as Colleges and Universities. The concentrated information is focused on a student's preferences and educational objectives. An institution of higher education is selected by a student's preference in institution location or education objectives. A pertinent selection criteria is also concentrated on institutions of higher education selected by a student's group of student friends who are also seeking an institution of higher education. By knowing where student friends are selecting institutions of higher education, a student can know, through this mobile application of the present invention where friends are enrolling in institutions where a student may have other selection criteria be met and knowing which institutions were selected by friends seeking similar educational objectives.

Primary areas of technical disclosure are data visualization, databases, infographics, social networks, aggregation of data, and associated techniques to visually display vast amounts of data in a concentrated and visual manner to students seeking an institution of higher education.

### BRIEF DESCRIPTION OF THE VARIOUS VIEWS OF THE DRAWINGS

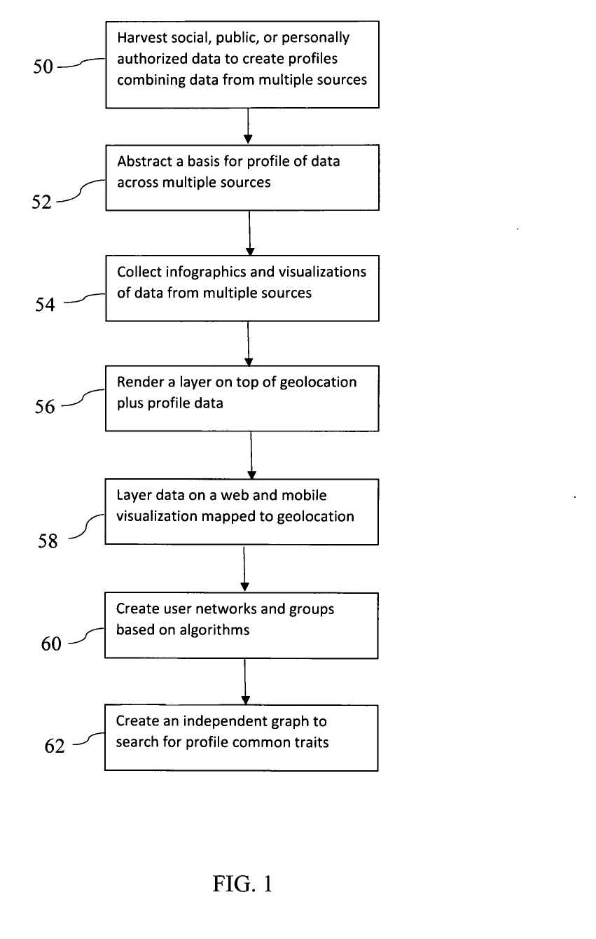

FIG. 1 is a flowchart of steps of the present invention, a Drove System and Method with the following steps:
i. Harvest social, public or personally authorized data to create profiles combining data from multiple sources 50;
ii. Abstract a basis for profile of data across multiple sources 52;
iii. Collect Infographics and visualizations of data from multiple sources 54;
iv. Render a layer of data on top of geolocation plus profile data 56;
v. Layer data on a web and mobile accessible visualization mapped to geolocation 58;
vi. Create user networks and groups based on algorithms 60;
vii. Create an independent graph to search for profile common traits 62;

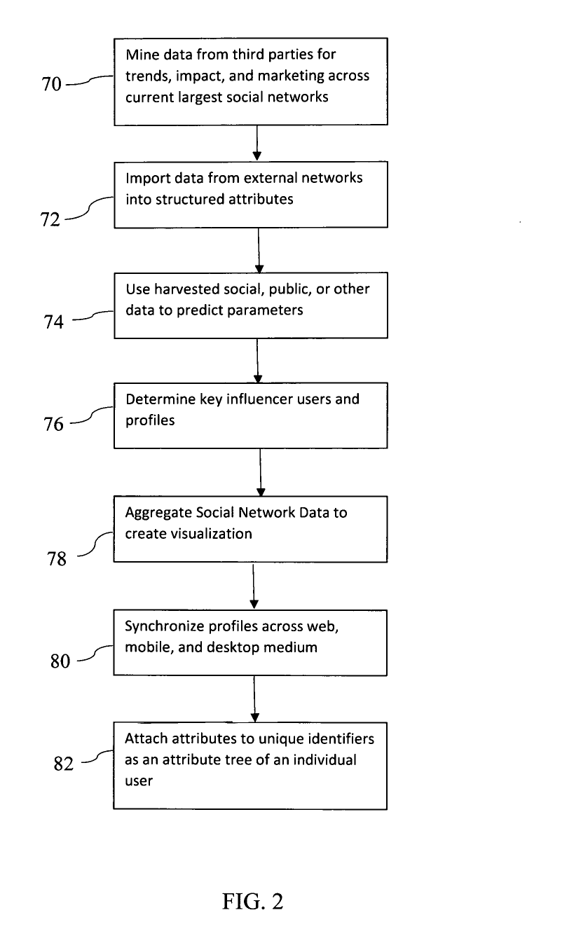

FIG. 2 is a flowchart continuation of steps of the present invention, a Drove System and Method with the following steps:
viii. Mine data from third parties for trends, impact, and marketing efforts across current largest social networks 70;
ix. Import data from external networks into structured attributes 72;
x. Use harvested social, public or personally authorized data to predict parameters 74;
xi. Determine key influencer users and profiles 76;
xii. Aggregate Social Network Data to create visualization 78;
xiii. Synchronize profiles across web, mobile, and desktop medium 80; and
xiv. Attach attributes to unique identifier as an attribute tree of an individual user 82.

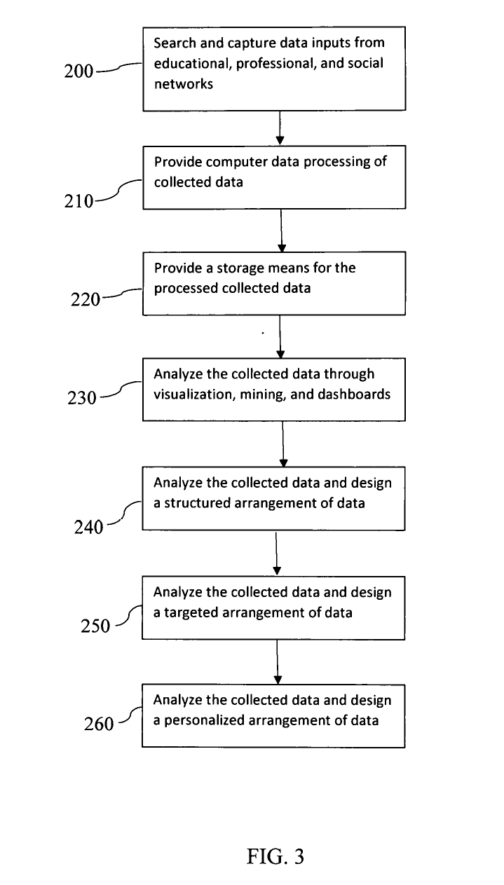

FIG. 3 is a flowchart of steps of the present invention, a Drove System and Method with the following steps:
i. Search and capture data inputs from educational, professional, and social networks 200;
ii. Provide computer data processing of collected data 210;
iii. Provide a storage means for the processed collected data 220;
iv. Analyze the collected data through visualization, mining, and dashboards 230;
v. Analyze the collected data and create and design a structured arrangement of data 240;
vi. Analyze the collected data and design a targeted arrangement of data 250; and vii. Analyze the collected data and design a personalized arrangement of data 260.

### DETAILED DESCRIPTION OF THE INVENTION

Incorporated by reference is US patent application U.S. 62/496,665, a provisional patent application filed Oct. 26, 2016 titled “Drove Mobile Application System and Method.

The present invention Drove Mobile Application System and Method provides students entering higher education with Data visualizations to concentrate on schools in a region, a State, or schools centered on a student's higher education objective. Further, the present invention provides students with information of which institution student peers and friends selected for their higher education.

The present invention Drove Mobile Application System and Method provides prospective students of higher education with a mobile application system and method which accomplishes the following objectives:
i. Harvest social, public or personally authorized data to create profiles combining data from multiple third party endpoints;
ii. Abstract logical façade for profile attributing of personal/professional/educational data across multiple sources, exposed via web services and API;
iii. Collect Infographics and visualizations of data from networks and multiple data points;
iv. Use a simplified design render layer on top of geolocation plus profile data to make more interesting and artistic representations of data;
v. Layer data on a web and mobile accessible visualization render canvas mapped to geolocation, including layers for physical locations, profile locations, location data related to education and employment;
vi. Create user networks and groups based on algorithms for finding interest in schools, jobs, and brand impact;
vii. Use harvested social, public, or personally authorized data to create an independent graph to search for profile common traits;
viii. Mine data from third parties for trends, impact, and marketing efforts across current largest social networks;
ix. Import data from external networks into structured common and standardized attributes;
x. Use harvested social, public or personally authorized date to predict following, attendance and market event successes;
xi. Use harvested information from common social, public and personally authorized data to find key influencer users/profiles that brands and advertising campaigns can reward for more impact;
xii. Aggregate Social Network Data in order to create visualization. Gamify profile creation to encourage harvesting of profile data using external sources;
xiii. Synchronize profiles across web, mobile, desktop using unique identifier; and
xiv. Attach attributes to unique identifier as an attribute tree of an individual user, allowing multiple third party authentication systems and apis to attach data to a user.

The various screens provided on web, mobile, and desktop medium, screens provided by the Drove System and Method are described herein:

An initial screen of the present invention displays a Log-in screen ‘Find your Flock with Facebook’. A student will enter an email address and password to log in to Drove—Find Your Flock, Mobile Application System and Method.

A subsequent a screen of the present invention displays a United States Map with a message ‘Find Your Flock while we're building your map’. This screen is a harvest screen wherein the Drove—Find Your Flock, Mobile Application System and Method screen aggregates information on a student who logged in.

A next screen of the present invention displays a navigation screen with six options, a search field labeled ‘Find’, ‘Fiends’ which if tapped will display students and friends linked to the student who logged in. Also displayed is a field ‘Chat’ 40 which if tapped will allow text communication with another student or friend. A ‘Notifications’ icon will convey notification information from the Drove—Find Your Flock, Mobile Application System and Method. A ‘map’ icon is also displayed which if tapped will display information on a map. A ‘profile’ icon is displayed, which if tapped will display profile information of the student who logged in.

Next is a screen of the present invention displaying a short cut screen with the icons of described above and an additional icon ‘Settings’ which if tapped will display settings of the Drove, Mobile Application System and Method.

A next screen of the present invention displays a ‘Find’ screen with selections of information including ‘Everything’ which if tapped will display all information on the student who logged in. Additional icons are ‘Friends’, which if tapped will display friends linked to the student who logged in. In addition is an icon ‘Co-Workers’ which if tapped will display co-workers linked to the student logged in. Additional icons are ‘Networks’ which will display linked networks and a ‘Schools’ icon which will display linked schools with school information.

A further screen of the present invention displays a ‘Notifications’ screen with notifications icons from ‘In Networks, Out of Network, and All’ which if tapped will display the tapped information, either in networks, out of networks and all linked information. ‘Notifications’ screen shows three types of notifications from ‘Fiends’, ‘Notifications from the Drove, Mobile Application System and Method’, and ‘Notifications from Schools’.

A next screen of the present invention displays ‘Friends’ screen with ‘Recently Added’ friends shown with a picture display of these friends.

A next screen of the present invention displays a ‘Friends’ screen with a ‘Recently Added’ icon. In this screen, there is a ‘View Profile, Comment, and Chat’ icon selections. Also displayed are ‘Pictures of Friends’.

A further screen of the present invention displays a ‘Chat’ screen showing a ‘Friend Name’ displaying ‘Text’.

A next screen of the present invention displays ‘Profile’ screen with ‘Profile Information’. Through this ‘Profile’ screen profile information can be updated. Next is a screen of the present invention which displays an ‘Explore a Region’ screen. Through this screen, friends, colleges, and other pull down information can be displayed.

A next screen of the present invention displays a ‘Region Map’ which displays information on a region map of friends, colleges and universities, and linked information. Next is a screen of the present invention which displays a ‘State Map’ which displays information on a State map of friends, colleges and universities, and linked information.

A further screen of the present invention displays a ‘School Display’ with a specific school displayed. From a pull down menu, friends attending this school can be displayed and other information specific to this school can also be displayed.

Next is a screen of the present invention which displays a ‘Friends at School’ screen which displays friends attending this particular school.

A next screen of the present invention displays a ‘Settings’ screen with fields for ‘Notifications’ where a student can select notifications from High School, City, State, or Global. A ‘Theme’ field filters map results from friends, high school, and university. A further screen of the present invention displays a ‘Profile’ screen to enter ‘User Name and Password’.

A next screen of the present invention displays a ‘Profile’ screen to enter ‘Email’. Next is a screen of the present invention which displays a ‘Profile’ screen to enter ‘First Name, Last Name, and Birthday’.

A next screen of the present invention displays a ‘Profile’ screen to enter ‘High School and Class Year’.

Next is a screen of the present invention which displays a ‘Profile’ screen to enter ‘City’.

A next screen of the present invention displays a ‘Profile’ screen to enter ‘Attended College of University?’.

Next is a screen of the present invention which displays a ‘Profile’ screen to enter ‘Name of School, Major, Start and End Dates’.

A next screen of the present invention displays a ‘Profile’ screen to enter ‘Save Image’.

A further screen of the present invention displays a ‘Profile’ screen to enter ‘Profile Display of Information’.

Next is a screen of the present invention which displays a ‘Profile’ screen to enter ‘Add More Images’.

We will further describe the Drove Mobile System and Method starting with data visualizations. Data visualizations in the Drove mobile application system and method is a method to display more complex forms of expressing the meaning of data. Through network graphs, we can see the connectivity between a number of entities, such as education and social networks.

Data visualizations are interactive in nature in the present invention. This allows interaction between certain data points or to manipulate and change views of the information to reach more insight into the collected data.

Infographics are another form of data visualization used by the present invention. The use of infographics involves the creation and sharing of content in order to engage with students who will use the present invention.

The present invention depends on visual display of vast amounts of information found in educational and social databases for providing concentrated information to students seeking an institution of higher education such as Colleges and Universities. The concentrated information is focused on a student's preferences and educational objectives. An institution of higher education is selected by a student's preference in institution location or education objectives. A pertinent selection criteria is also concentrated on institutions of higher education selected by a student's group of student friends who are also seeking an institution of higher education. By knowing where student friends are seeking institutions of higher education, a student can know, through this mobile application of the present invention, where friends are enrolling in institutions, where a student may have other selection criteria be met, and knowing which institutions were selected by friends seeking similar educational objectives.

Primary areas of technical disclosure by the present invention are data visualization, databases, infographics, social networks, aggregation of data, and associated techniques to visually display vast amounts of data in a concentrated and visual manner to students seeking an institution of higher education.

Data visualization in the present invention is visual representation of data, meaning “information that has been abstracted in some schematic form, including attributes or variables for the units of information”. The main goal of data visualization in the present invention is to communicate information clearly and effectively through graphical means to students entering higher education.

The present invention has a focus on information presentation through Data visualization. There are two main parts of this data visualization: statistical graphics, and thematic cartography.

Data analysis is the process of studying and summarizing data from educational and social databases with the intent to extract useful information to provide prospective students of higher education with data needed to develop conclusions. Data analysis used in the present invention is closely related to data mining, which is also used by the present invention, but data mining tends to focus on larger data sets.

Data analysis used in the present invention is divided into descriptive statistics, exploratory data analysis, and infinitival statistics (or confirmatory data analysis) where the EDA (exploratory data analysis) focuses on discovering new features in the data, and CDA (confirmatory data analysis).

Types of data analysis in the Drove mobile application are:

Exploratory data analysis (EDA): an approach to analyzing data for the purpose of formulating hypotheses worth testing, complementing the tools of conventional statistics for testing hypotheses.

Qualitative data analysis (QDA) or qualitative research is the analysis of non-numerical data, for example words, photographs, observations, etc.

Data mining in the present invention is the process of sorting through large amounts of education and social data and picking out relevant information. Data mining has been described as the “nontrivial extraction of implicit, and potentially useful information from data” and the “science of extracting useful information from large data sets or databases”. In relation to the objectives of the present invention, data mining is the “statistical and logical analysis of large sets of education and social data, looking for patterns that can aid decision making” for a student seeking an institution of higher education.

To create truly powerful data visualization to a student seeking higher education a combination of artistic, statistical, and mathematical skills are used. The use of data visualization is effective to communicate information both quickly and effectively as possible for a student of higher education to make a decision on an institution of higher education.

Creating data visualization in the present invention is more than simply translating a table of data into visualization. Data visualizations communicate data in the most effective way, to truly reveal the data they should be quick, accurate, and powerful. Creating visuals can easily summarize and communicate data to students seeking higher education—making even the largest or most complicated sets of data understandable. There are various stages for educational and social data visualization. First is to acquire the data. Second is to organize the data ideally for visualizing it. The data must be given structure by organizing it into categories. The data must be filtered, remove all but the data of interest. Then apply methods from statistics or data mining as a way to find patterns or meaning in the data. Choose a basic visual model to visualize the data. Then improve the basic representation to make it clearer and more visually engaging. Then add methods for manipulating the data, allowing users to control what they see, or how they see it.

Creating powerful data visualization is not about simply translating educational and social data into a visual graphic. It is about communicating the meaning of the data. Choosing the most adequate visualization design pattern is an important step because it will immediately tell students of higher education about how the data is organized and what you are trying to communicate about the data. However, it is not only the type of visualization pattern chosen-but also the design of the individual elements that play an important role in communicating information to students of higher education. There are certain visual features in design that will work pre-attentively; they will communicate something about the design before a student of higher education pays conscious attention to it. A powerful data visualization should work quickly and effectively, therefore the visual design should help reveal the data to students of higher education. Properly applying visual variables is what allows large sets of data to be quickly and accurately understood in data visualizations.

Until recently, all data visualizations were static and predefined: however, many modern data visualizations are created using multimedia interfaces to mobile devices such as smartphones, tablets, personal digital devices, and computers that expand the possibilities of data visualizations, as in the present invention.

When working with multimedia interfaces there are new factors which can influence the effectiveness of communicating information to users. The most limiting factor of multimedia is the relatively small amount of information that can be displayed on a screen, but the main advantage of using multimedia is that visualizations can be dynamic, animated, and allow for student interaction.

Drove Mobile Application System and Method Data Visualization

Data visualization is the technique used by the Drove Mobile Application System and Method to convey concentrated information in visual form to students of higher education served by the present invention. Data visualization has been used for some time to distill and communicate information. Typical are maps, graphs, and charts, however, with advancements in technology, data visualizations are taking on more complex forms than before as shown in the present invention. This technology brings forward the meaning behind big data sets that would be unmanageable to understand otherwise. This is becoming known as “big data”.

The term “big data” is used to describe data sets with a size and complexity beyond the ability of typical database software tools to capture, store, manage and analyze these large date sets.

The rise of big data comes from two main factors:

The increased generation of information

The ability to store this information

Both of these factors are tied to the advancements in technology. Education and social media applications have generated huge amounts of information online where education and personal information is being collected.

The purpose of the present invention, Drove Mobile Application System and Method, is to extract meaning from immense amounts of data, educational and social networking data and other data sets.

The objective of the present invention is to extract value from big data. The following steps are typical of the creation and final analysis and action on the visualization of the captured data:

Step One: Data Inputs from education and social networks.
Step Two: Data Processing of the collected data.
Step Three: A storage means for the data.
Step Four: Analysis of the collected data through visualization, mining, dashboards.
Step Five: Action on the analysis of the data such as design, targeting, and personalization shown by the present invention.

The field of data visualization as used in the present invention can improve this scenario. The power of data visualization is the transformation of vast amounts of data sets into a visual rendering. Data visualization can use abstract non-representational pictures to show numbers and other quantities. It can include points, lines, symbols, words, shading, and color. Data visualization makes it easier to spot trends and patterns amid large amounts of education and social information. Social network aggregation is also a method used by the present invention.

### Drove Mobile Application System and Method Social Network Aggregation

Social network aggregation is the process of collecting content from multiple social network services, such as MySpace or Facebook. This task is performed by the present invention by pulling together information into a single location to consolidate multiple social networking profiles into one profile. The present invention consolidates messages, tracks friends, combines bookmarks, also searching across multiple social networking sites, reading feeds from multiple social networks, seeing when a name is mentioned on various sites, or accessing student profiles from a single interface.

Social network aggregation allows students to share their other social network activities like Twitter, Youtube, Stumbleupon, Digg, Delicious, and other major platforms. One can also integrate their blog posts and comments in the aggregation platform of the present invention. Everything is shown in real time to other students who subscribe to the Drove Mobile Application System and Method.

This aggregation in the present invention is done by an API (application programming interface) application. For the API to be able to access a student's actions from another platform, the student will have to give permission to the social aggregation platform, by specifying user id and password of the social media to be syndicated. This concept is similar to open id.

Social network aggregation systems can rely on the initiation of publishers or readers. In the publisher-initiated aggregation systems, the publishers combine their own identities, which make their readers see all aggregated content once subscribing to. In the reader-initiated systems such as Windows phone 7 people hub, and Linked Internet UI, the readers combine the identities of others, which have no impact to the publishers or other readers. Consequently, such systems allow publishers to keep separate identities for different readers.

### Drove Mobile Application Aggregation of Data Across Social Networks

Aggregation of data across social networks brought forward an idea of a technology to interconnect social networks together, “Instead of a giant centralized social network with 1,000,000 members, prefer to see 1,000,000 social nets with 10-25-150 members each. The shift in terminology form the “online communities” to the “social networks” of today reflects a change in character of group affiliations online.

There is some benefit in creating a “giant centralized social network”, by a means of creating some local order across multiple networks. The name they give to the technology for doing this is Digital Lifestyle Aggregators. The concept seems to be a set of standards and open source API's to support aggregation of person-related data across social network sites, blogs, personal media collections (like photos in Flickr), electronic and mobile communications.

### Drove Mobile Application System and Method Databases

The information used by the present invention and social networking revolve around data. A key difference between information and data is that information is processed data. The cumulative order is Data, Information, Knowledge, Understanding, and Purpose, such as provided by the present invention, Drove Mobile Application System and Method.

Data is processed to provide Information, which in turn provides Knowledge to the user, such as students using the Drove Mobile Application System and Method. Knowledge then leads to Understanding and thereby provides Purpose which leads to action by selecting an institution of higher learning. Databases as used in the present invention are structures that hold institutional and social data. The software that enables the flow of data through these structures is called a database management system or DBMS. The most widely used system of DBMS is called RDBMS or Relational DBMS. This means that data is stored in tables and the relationships that exist within the data are stored within tables. The following are three parts that make a database as used by the present invention:

Tables: a matrix of rows and columns. Each row is a record, or a unit of data. A record (row) can have several columns or fields. Each field is like an attribute of that record.

Queries: A query is a question posed to the database, to retrieve a specific set of records, based on conditions supplied in the query.

Views: These are virtual tables, or a set of stored queries.

At a physical level, the data is stored in data files specific to the DBMS.

A database of the present invention is accessed, read from and written to, using an interface that allows applications to store and retrieve data. This interface is called an interface driver or database driver. ODBC (Open Data Base Connectivity) is a database driver. A program of the present mobile application needs to store and read data, using an API (Application Programming Interface—a collection of functions)) provided by ODBC to do so. Similarly, there is JDBC (Java Data Base Connectivity) and others that can be used by the Drove mobile application.

A means to communicate with a database of the present invention is through a Structured Query Language called SQL. SQL statements allow for creation or control of data sets in the Drove mobile application. There are four types of SQL statements used for creation or control of the Drove data sets:

DDL (Data Definition Language)

DML (Data Manipulation Language)

DCL (Data Control Language)

TCL (Transactional Control Language)

### Drove Mobile Application Databases and Cloud-Based Computing

The Drove Mobile Application System and Method utilizes non-relational and relational databases and cloud based computing. With the advent of cloud-based computing, there has been an increased need for Web-capable databases to serve up, store and manage large amounts of content. Content such as Facebook's user profiles and posts for millions around the world: Google's billions of searches and Web crawls of other websites: Dropbox's millions of stored user documents and files: eBay's millions of auction listings, and so on. Broadly speaking, the word for this area is “big data”, data which is managed under the present invention.

For all these Web-centric databases, the main concern is scalability. As more and more applications are launched in environments that have massive workloads (such as the diverse range of Web services available on the Web today), their scalability requirements can change very quickly and grow very large. Relational databases scale well, but usually only when that scaling happens on a single server. When the capacity of that single server is reached, you need to scale out and distribute that load across multiple servers, moving into so-called distributed computing. This is when the complexity of relational databases starts to rub against their potential to scale. By scaling to hundreds or thousands of servers, the complexities become overwhelming. The characteristics that make RDBMS advantageous are the very same that also reduce their viability as platforms for large distributed systems. The Drove Mobile Application System and Method utilizes relational databases from institutional and social networks.

### Drove Mobile Application Non-Relational Databases

Non-relational databases, specifically a database's key-value stores or key-value pairs, are different from relational databases. Key-value pairs allows storage of several related items in one “row” of data in the same table. The word “row” is in quotes because a row here is not the same thing as a row of a relational table. This seems superior for storing data in the present invention. The problem with key-value stores is that, unlike relational databases, they cannot enforce relationships between data items. The information is stored under one record, as compared to relational databases where information is stored in various tables.

### Drove Mobile Application Data Warehouses

A data warehouse is a special type of database optimized for querying, reporting and analysis and are used in the present invention. The data in the warehouse is almost always read-only and typically originates from the operational database and other systems. It is then set up to upload at periodic intervals to the warehouse using extraction, transformation, and loading (ETL) processes to turn it into a form more suitable for reporting and deeper analysis. The main benefit of reporting using data warehouses as opposed to transactional databases is that the warehouses allow much better and more fine-grained data analysis. Use of a data warehouse also removes the reporting load from the main transactional system. In addition, data warehouses also keep a clear and complete history of all date history, even though the transactional system may not offer this ability.

Data warehouses are distinct from typical databases in that they are used for more complex analysis of institutional and social data as in the present invention. This differs from the transactional database, whose main use is to support operational systems and offer day to day, small scale reporting.

### Drove Mobile Application Database Structure

### Tables

The table is the basic data-storage unit in a relational database of the present invention. Tables consist of columns and rows. The columns are the attributes or qualities that we want to express, while the rows hold the actual data, with one or no items per row.

### Relationship

Relationships are the reason why relational databases work well in the Drove Mobile Application System and Method. In these institutional and social relational databases, a relationship exists between two tables when one of them has a foreign key that references the primary key of the other table. The following explains the structure of the Drove mobile application relational databases, row, column, and primary key, and foreign key:

### Row

A row, also called a record, represents a set of data about a specific item. Every record in a table has exactly the same structure, but different data.

### Column

A column is a specific set of values in a table of the same type. It defines a specific attribute of the table or data.

### Primary Key

A primary key is a special column or combination of columns that uniquely identifies each record (row) in the table. The primary key column must be unique for each row, and must not contain any nulls (non-values).

### Foreign Key

A primary key uniquely defines a record, while a foreign key is used to reference the same record from another table.

One of the fundamental concepts of relational databases is that of referential integrity. This rule states that relationships between tables must always remain consistent. In other words, any field located in a foreign key must be in agreement with the primary key that the foreign key references. Therefore, any updates or deletions to a primary field must either also be applied to all its foreign keys, or must not be allowed to happen. The same restriction also applies to foreign keys; any updates must either also be propagated back to the corresponding parent primary key, or not allowed.

### SQL

Structured Query Language (SQL) is a language used for the management and manipulation of data in institutional and social relational databases of the present invention. SQL can be used to query, insert, update and modify data. Institutional and social relational databases support SQL, makes SQL a language of preference for the Drove mobile application.

### Drove Mobile Application System and Method Databases Summary

A database as used in the Drove mobile application, in the most general sense, is an organized collection of institutional and social data. More specifically, a database is an electronic system that allows data to be easily accessed, manipulated and updated.

A relational database in the Drove mobile application is essentially a group of tables or, to use the technical name, entities. Each table is made up of rows (tuples) and columns (attributes). The tables have relationships between them that are defined as using a certain column in one table that references a column in another table.

The table is the basic data-storage unit in a relational database. Tables consist of columns and rows.

Relationships are the reason why relational databases work so well. In relational databases, a relationship exists between two tables when one of them has a foreign key that references the primary key of the other table.

A row, also called a record, represents a set of data about a specific item. Every record in a table has exactly the same structure, but of course different data.

A column is a specific set of values in a table of the same type. It defines a specific attribute of the table or data.

Spreadsheets and databases have some similar capabilities, but the spreadsheet has a number of limitations that make it unsuitable for managing some data situations.

One limitation of relational databases is that each item can only contain one attribute. Non-relational databases, specifically a database's key-value stores or key-value pairs, are radically different from this model. Key-value pairs allow storage of several related items in one row of data in the same table.

A data warehouse is a special type of database optimized for querying, reporting, and analysis. The main benefit of reporting using data warehouses, as opposed the organization's transactional databases, is that the warehouses allow much better and more fine-grained data analysis for business consumption.

An index is an RDBMS is a data structure that works closely with tables and columns to speed up data retrieval operations.

A schema is the structure behind data organization. It is a visual overview of how different tables are related to each other.

Normalization is the process of (re)organizing data in a database so that it meets two basic requirements: there is not data redundancy (all data is stored in only one place) and data dependencies are logical (all related data items are stored together).

### Drove Mobile Application System and Method Infographics

As presented by the Drove mobile application of the present invention, Information graphics or infographics are graphic visual representations of information, data or knowledge intended to present complex information quickly and clearly. Infographics can improve cognition by utilizing graphics to enhance the human visual system's ability to see patterns and trends. The process of creating infographics can be referred to as data visualization, information design, or information architecture.

Social media sites such as Facebook and Twitter have compiled individual infographics which are utilized by the Drove mobile application for its social database. Such infographics are between shared between users of the Drove mobile application.

### Analysis of Drove Mobile Application Infographics

The three parts of Drove mobile application infographics are the visual, the content, and the knowledge. The visual consists of colors and graphics. There are two different types of graphics-theme and reference. Theme graphics are included in all infographics and represent the underlying visual representation of the data. Reference graphics are generally icons that can be used to point to certain data.

Statistics and facts usually serve as the content for Drove mobile application infographics, and can be obtained from a number of sources. One of the most important aspects of Drove mobile application infographics is that they contain some sort of insight into the data that they are presenting of academic institutional and social data, which is the knowledge.

Infographics are effective because of their visual element. Students using the Drove mobile application of the present invention receive input and significantly more information from vision than any other senses. Fifty percent of the human brain is dedicated to visual functions, and images are processed faster than text. The brain processes pictures all at once, but processes text in linear fashion, meaning it takes much longer to obtain information from text. Furthermore, it is estimated that 65% of the population are visual learners (as opposed to auditory or kinesthetic), so the visual nature of the Drove mobile application infographics caters to students using this mobile application.

Academic Institutional and Social data is being made more relevant to students through a guidance design technique that leads the eye.

When designing the visual aspect of a Drove mobile application infographic, a number of considerations were in the design of Drove infographics to optimize the effectiveness of the visualization. The six components of visual encoding are spatial marks, connection, enclosure, retinal properties, and temporal encoding. Each of these can be utilized in its own way to represent relationships between different types of data. However, spatial position is the most effective way to represent numerical data and leads to the fastest and easiest understanding by students using this mobile application. Therefore, the Drove mobile application designs often spatially represent the most important relationship being depicted in an infographic.

There are also three basic provisions of communication that were assessed by the Drove mobile application when designing an infographic which are appeal, comprehension, and retention. Appeal is the idea that the communication needs to engage its student audience. Comprehension implies that the student should be able to easily understand the information that is being presented to them. And finally, retention means that the viewer student remembers the data presented by the infographic. The order of importance of these provisions depends on the purpose of the Drove infographic. If the infographic is meant to convey information in an unbiased way, such as in the domains of academia or science, comprehension should be considered first, then retention, and finally appeal. However, if a Drove infographic is being used for social purposes, then appeal becomes the most important, followed by retention and comprehension

When the varieties of factors listed above were taken into consideration when designing Drove mobile application infographics, they can be highly efficient and effective to convey large amounts of information in a visual manner.

### Data Visualization in Drove Mobile Application Infographics

Data visualizations are used in Drove mobile application infographics and may make up an entire infographic. There are many types of visualizations that can be used to represent the same set of data. Therefore, it is crucial to identify the appropriate visualization for the data set and infographic by taking into consideration graphical features such as position, size, shape, and color. There are primarily five types of Drove mobile application visualization categories which are time series data, statistical distributions, maps, hierarchies, and networking.

Time Series Data

Time series data is one of the most common forms of data visualization. It documents sets of values over time. Examples of graphics in this category include index charts, stacked graphs, small multiples, and horizon graphs. Index charts are ideal to use when raw values are less important than relative changes. It is an interactive line chart that shows percentage changes for a collection of time series data based on a selected index point. Stacked graphs are area charts that are stacked on top of each other, and depict aggregate patterns. They allow students to see overall patterns and individual patterns. An alternative to stacked graphs is small multiples. Instead of stacking each area chart, each series is individually shown so the overall trends of each sector are more easily interpreted. Horizon graphs are a space efficient method to increase the data density of a time series while preserving resolution.

Statistical Distributions

Statistical distributions in the Drove mobile application reveal trends based on how numbers are distributed. An example is histograms which convey statistical features such as mean, median, and outliers. In addition to these infographics, alternatives include stem and leaf plots, Q-Q plots, scatter plot matrices (SPLOM) and parallel coordinates. For assessing a collection of numbers and focusing on frequency distribution, stem and leaf plots can be helpful. The numbers are binned based on the first significant digit, and within each stack binned again based on the second significant digit. On the other hand, Q-Q plots compare two probability distributions by graphing quintiles against each other. This allows the student to see if the plot values are similar and if the two are linearly related. SPLOM is a technique that represents the relationships among the multiple variables. It uses multiple scatter plots to represent a pair-wise relation among variables.

Another statistical distribution approach used in the Drove mobile application is to visualize multivariate data is parallel coordinates. Rather than graphing every pair of variables in two dimensions, the data is repeatedly plotted on a parallel axis and corresponding points are then connected with a line. The advantage of parallel coordinates is that they are relatively compact, allowing many variables to be shown simultaneously.

Maps

Maps in the Drove mobile application are a natural way to represent geographical data. Time and space can be depicted through the use of flow maps. Line strokes are used with various widths and colors to help encode information. Choropleth maps, which encode data through color and geographical region, are also commonly used in the Drove mobile application. Graduated symbol maps are another method to represent geographical data. They are an alternative to choropleth map and use symbols, such as charts for each area, over a map. This map allows for more dimensions to be represented using various shapes, size, and color.

Cartograms, on the other hand, completely distort the shape of a region and directly encode a data variable. Instead of using a geographic map in the Drove mobile application, regions are redrawn proportionally to the data. For example, each region can be represented by a circle and the size/color is directly proportional to other information.

Hierarchies

In the Drove mobile application, Enclosure diagrams are also a space filling visualization method. However, they use containment rather than adjacency to represent the hierarchy. Similar to the adjacency diagram, the size of the node is easily represented in this model.

While all of the above Drove mobile application visualizations can be effectively used on their own, Drove infographics combine multiple types into one graphic, along with other features, such as illustrations and text.

### Summary of Objectives of the Drove System and Method:

i. Drove mobile application is a digital platform and exclusive social network for high school students making the transition into higher education resembling a platform such as LinkedIn for High School Students.
ii. Drove mobile application is uniquely developed to interact with annual marketing spent by colleges and universities on digital marketing, including Facebook and Google.
iii. Current education marketing campaigns are not efficient, casting a very wide net with little ability to reach the right student at the right time.
iv. Drove mobile application is designed to create a unique, intrusive free, marketing experience to highly engaged and active high school users

### Drove Mobile Application System and Method Audience

Two unique audiences: High school students and colleges/universities
High school students looking for colleges are already on social media
   Drove mobile application could influence approximately 5.25 million U.S. High School Juniors & Seniors on Facebook
      71% of American teens 13 to 17 use Facebook, half of teens use Instagram and 40% use Snapchat. 71% of teens use more than one social network site as reported in Pew 2015.
Colleges & universities pay to attract the right type of students
   There are approximately 5,000 universities and colleges in the US.
   These universities spend on avg. $5M each on digital marketing and outreach each year
      This varies by school some higher or lower. For example, DeVry Inc. spent $41.2M in the first 6 months of 2013.

### Current Education Marketing

Current Education Marketing campaigns are not efficient not efficient at reaching the right student and the right time.
   1. Deceptive co-registration paths that pressure potential students into enrolling with a barrage of spam and phone calls.
   2. Traditional (expensive) billboard, leaflet/pamphlet disbursement and TV ad buys casting a wide net with little direct attribution.
   3. Paid Search advertising has a limited ability to target due to inability to generate keyword demand, only capitalize on it
Drove Mobile Application System and Method is different.
   1. The Drove mobile application creates a platform where our user is exactly the target demographic that our advertising colleges/universities are looking to attract.
   2. Our highly engaged and high intent users will explore colleges/universities without the feeling of being marketed to.
   3. Unlike most mobile applications focusing only on user growth to later monetize with intrusive advertising, Drove is starting with a seamless high-value model.
Drove has a unique opportunity to revolutionize the search process for higher education while creating a more fulfilling educational experience through social inclusion.

### The Power of Drove Mobile Application Networks:

Drove mobile application is “a digital platform and exclusive social network for high school students making the transition into higher education”
A dual value proposition product: Students and Schools:
   Students can easily browse Drove's mobile application recommendations —powered by a unique deep learning algorithm—to review detailed school information, message fellow students for insights and create a profile to get noticed by schools and classmates.
   Schools can customize a profile for students to review and engage with, visualize and target a network of prospective students, and connect with individuals who are ready to apply or learn more.
Drove mobile application was created with the vision to enable students to leverage the powerful social connections high-schoolers already have and enable them to connect with current/future peers and schools in a mobile application.
   The company was built around the underlying principle that people are innately curious and social. People want to be aware of where their friends are and often want to follow them to those destinations
The Drove mobile application comprises map visualization functionality, profile building and data linking.
The Drove mobile application includes additional features such as refined map-based search and enhanced profiles.
The Drove mobile application develops, trains and launches a deep learning recommendation engine to provide students with a game-changing start to their school search.
The Drove mobile application provides schools with unique data sets around students interested or potentially interested in their university.
The Drove mobile application brings new features to schools such as advanced targeting, school office hours for chat/school chat bots and a visual profile overhauls.
   The Drove mobile application provides access on the platform for either high schooler students or schools.
Drove mobile application allows schools to have a custom presence within the mobile application.
In the Drove mobile application schools choose between tiered levels of customizations of their page.

### Drove Mobile Application System and Method Long Term Roadmap;

The Drove Mobile Application System and Model is adaptable to expand as follows:
Follow the Drove audience as they grow by expanding the product to adjacent categories:
   Individuals looking for secondary education MBAs, PHDs.
   People looking to transition into a skill they are more passionate about.
Become a leader in the education space in data and recommendations
   Tune the machine deep learning engine with all the student and school data as more students use the network.
Apply the Drove platform and engine to other industries with similar needs.

### Advantages of the Drove Mobile Application System and Method

A comparable direct system and method is not in the market today. Students use a wide range of resources to find the right school to attend, their tools currently include a great deal of offline resources.
Students use:
   Family recommendations
   School websites
   High school counselors
   Physical school guidebooks
   College ranking books and websites
Some students surveyed will use the rating service Niche (formerly CollegeProwler)
   The site includes school info as well as student reviews, similar to Yelp
   Currently only a web presence, no app
The closest comparable product is the Princeton Review
   The service has added school research to their product offering in addition to test prep. A student can search and review school information that includes admissions details, student life information and tuition data.
   A mobile-specific version called the College Advisor enables students to search for, read about universities and receive recommendations.
      The experience starts with a questionnaire about your school preferences then provides suggestions after a log-in.
      It includes a hot or not style selector on dream schools and safety schools. A user can review and save schools as well as search for them manually.
      Discovering profiles of other students or chat capabilities are not in the feature set. The power of the network is missing.
None of these services takes in personal interests, friends and family recommendations and provides networking capabilities for finding the right school.

The present invention Drove Mobile Application System and Method has been described in terms of specific embodiments incorporating details to facilitate the understanding of principles of construction and operation of the invention. Such reference herein to specific embodiments and details thereof is not intended to limit the scope of the claims appended thereto. It will be readily apparent to one skilled in the art that other various modifications may be made in the embodiment of the chosen for illustration without departing from the spirit and scope of the invention as defined by the claims.

What is claimed is:

1. A Drove System and Method to select specific visual information to provide guidance to prospective students to select an institution of higher learning, the selection of specific visual information keyed to a profile of a specific student comprising the following steps:
xv. Harvest social, public or personally authorized data to create profiles combining data from multiple sources;
xvi. Abstract a basis for profile of data across multiple sources;
xvii. Collect Infographics and visualizations of data from multiple sources;
xviii. Render a layer of data on top of geolocation plus profile data;
xix. Layer data on a web and mobile accessible visualization mapped to geolocation;
xx. Create user networks and groups based on algorithms;
xxi. Create an independent graph to search for profile common traits;
xxii. Mine data from third parties for trends, impact, and marketing efforts across current largest social networks;
xxiii. Import data from external networks into structured attributes;
xxiv. Use harvested social, public or personally authorized data to predict parameters;
xxv. Determine key influencer users and profiles;
xxvi. Aggregate Social Network Data to create visualization;
xxvii. Synchronize profiles across web, mobile, and desktop medium; and
xxviii. Attach attributes to unique identifier as an attribute tree of an individual user.

2. A Drove System and Method as in claim 1 wherein harvesting of social, public, or personally authorized data comprises creating select profile criteria to combine data from multiple datasets to create a particular defined profile.

3. A Drove System and Method as in claim 1 wherein abstracting a basis for profile of data across multiple sources comprises determining profile variables to abstract specific and defined data.

4. A Drove System and Method as in claim 1 wherein collecting infographics and visualization data from multiple sources comprises determining profile variables to collect specific and defined data.

5. A Drove System and Method as in claim 1 wherein rendering a layer of data on top of geolocation plus profile data comprises determining select criteria to combine infographics and visualization data onto a geolocation plus profile dataset.

6. A Drove System and Method as in claim 1 wherein layering data on a web and mobile visualization mapped to geolocation comprises selecting specific criteria based on profile to layer data mapped by a geolocation dataset.

7. A Drove System and Method as in claim 1 wherein creating user networks and groups based on algorithms comprises creating of algorithms for finding interest in schools, jobs, and brand impact to define and integrate select user groups and networks.

8. A Drove System and Method as in claim 1 wherein creating an independent graph to search for profile common traits comprises determining criteria of common traits to extract data based on this criteria to create an independent graph dataset to be a basis for profile common traits.

9. A Drove System and Method as in claim 1 wherein mining of data from multiple sources comprises determining select criteria to identify trends, impact, and marketing across social network datasets.

10. A Drove System and Method as in claim 1 wherein importing data from external networks comprises creating select criteria to import data into structured common and standardized attributes.

11. A Drove System and Method as in claim 1 wherein using harvested social, public, or personally authorized data to predict parameters comprises creating select criteria to harvest data to predict following, attendance, and market event successes.

12. A Drove System and Method as in claim 1 wherein determining key influencer users and profiles comprises creating select criteria to determine key influencer users and profile parameters.

13. A Drove System and Method as in claim 1 wherein aggregating social network data to create visualization comprises creating select criteria to aggregate social network data to create visualization of this dataset.

14. A Drove System and Method as in claim 1 wherein synchronizing profiles across web, mobile, and desktop medium comprises creating select criteria to synchronize profiles across the various mediums.

15. A Drove System and Method as in claim 1 wherein attaching attributes to unique identifiers as an attribute tree of an individual user comprises creating select criteria to further create a dataset with unique identifiers and an attribute tree of an individual user.

16. A Drove System and Method to aggregate and integrate data from educational, professional, and social network datasets to provide unique data visualization to an individual user comprising the steps of:
i. Search and capture data inputs from educational, professional, and social networks;
ii. Provide computer data processing of collected data;
iii. Provide a storage means for the processed collected data;
iv. Analyze the collected data through visualization, mining, and dashboards;
v. Analyze the collected data and create and design a structured arrangement of data;
vi. Analyze the collected data and design a targeted arrangement of data; and
vii. Analyze the collected data and design a personalized arrangement of data.

17. A Drove System and Method as in claim 16 wherein searching and capturing data inputs from educational, professional, and social networks comprises selecting profile criteria to combine data from multiple datasets to create a particular defined profile dataset.

18. A Drove System and Method as in claim 16 wherein providing computer data processing of collected data comprises abstracting a basis for profile of data across multiple sources to process this data into infographic and visualization programming.

19. A Drove System and Method as in claim 16 wherein analyzing the collected data through visualization, mining, and dashboards comprises layering data on top of geolocation data plus profile data to combine infographics and visualization data onto a geolocation plus profile dataset.

20. A Drove System and Method to harvest and extract data from educational, professional, social, and related datasets for purpose of creating a defined dataset based on individual profiles of intended users by layering various abstracted datasets to create infographics and visualization datasets for display to an individual user to inform an individual user of institutions of higher learning of parameters pertinent to a user's profile.
